(19) United States
(12) Patent Application Publication
(10) Pub. No.: US 2005/0061571 A1
(43) Pub. Date: Mar. 24, 2005

(54) Tail pipe ornament & method

(76) Inventor: Terrance Chen, Fullerton, CA (US)

Correspondence Address: CONNORS ASSOCIATES, 1600 DOVE ST, SUITE 220, NEWPORT BEACH, CA, 92660, US

(21) Appl. No.: 10/665,652

(22) Filed: Sep. 19, 2003

(51) Int. Cl. B60K 13/04

(52) U.S. Cl. 180/309

(57) ABSTRACT

A tail pipe of an automotive exhaust system includes an ornamental element bearing or in the form of a symbol located at or near an outer end through which exhaust gas exits. The ornamental element is sized to provide a sufficient space to allow the exhaust gas to flow substantially unimpeded past the ornamental element.

### INCORPORATION BY REFERENCE

The inventor incorporates herein by reference any and all U.S. patents, U.S. patent applications, and other documents cited or referred to in this application or cited or referred to in the U.S. patents and U.S. patent applications incorporated herein by reference.

### DEFINITIONS

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

### BACKGROUND OF INVENTION

Automotive accessories are sold to consumers who desire to customize their automotive vehicles. One such an accessory is a chrome-plated tail pipe. The standard tail pipe is removed and the chrome-plated tail pipe is attached usually by welding it to the outlet of the muffler of the exhaust system. These tail pipes come in a wide variety of configurations, some of which have dual outlets and others have an outer end cut at an acute angle. The 2002 through 2003 (Volume 3) DT Sports catalogue discloses examples of such custom tail pipes distributed by Different Trends, LLC or Buena Park, Calif.

### SUMMARY OF INVENTION

This invention has one or more features as discussed subsequently herein. After reading the following section entitled DETAILED DESCRIPTION OF SOME EMBODIMENTS OF THIS INVENTION,” one will understand how the features of this invention provide its benefits. The benefits of this invention include, but are not limited to: a novel ornamental addition to custom tail pipes that appeals to many consumers, ease of installation, low cost manufacture, and enhanced appearance of tail pipes.

Without limiting the scope of this invention as expressed by the claims that follow, some, but not necessarily all, of its features are:

One feature of this invention is that it comprises a tail pipe ornament including an ornamental element at or near the exposed open end of a tail pipe from which exhaust gas exits the vehicle. The tail pipe ornament of this invention may be a sleeve that is adapted to be connected to the exposed open end of the tail pipe and includes the ornamental element, or it may be a standard tail pipe that is modified to include the ornamental element. In either case, the ornamental element includes a symbol. It is this symbol that appeals to the consumer, and it may take many different forms. It may be, for example, in the form of letters, numbers, any ornamental shape, or combinations thereof.

Two, the ornamental element may be mounted in a stationary position at or near the exposed open end of the tail pipe. It may be a support component or plate bearing the symbol, for example, an opening in a solid plate in the shape of a symbol or a solid plate with a symbol painted or otherwise imposed thereon. The ornamental element may also be in the shape of the symbol. For example, the ornamental element may be essentially a solid structure that prevents exhaust gas from flowing therethrough. Or, the ornamental element may be essentially an open structure that allows exhaust gas to flow therethrough. An ornamental element may have at least a portion that is light reflective. For example, the portion that is light reflective may correspond to the symbol.

Three, the ornamental element is sized to provide sufficient space to allow exhaust gas to exit the exposed open end of the tail pipe without substantially impeding gas flow. Typically, the exposed open end of the tail pipe has a maximum total area and the ornamental element occupies no more than 90 percent of this maximum total area. For example, the maximum total area may be from about 8 to 20 about square inches. When the ornamental element occupies no more than about 90 percent of this maximum total area, the exhaust gas flows past the ornamental element unimpeded. If the ornamental element is an opening in a solid plate, the opening constitutes no more than about 90 percent of this maximum total area.

Four, a tubular member or sleeve may be employed. When this invention comprises a modification of a standard tail pipe, this standard pipe includes a tubular member. When this invention comprises an ornament adapted to be connected to the exposed open end of a standard tail pipe, it includes a sleeve that is connected to the exposed open end of the tail pipe either fitted over this end or pushed into this end. Both the tubular member of the standard tail pipe and the sleeve have a longitudinal axis and provide a passageway extending between the exposed open end and an inner end in communication with the exhaust system of the vehicle. The exhaust gas flows between the inner end and the exposed open end through the passageway. Thp tubular member, sleeve, and ornamental element usually are made of stainless steel and may be chrome plated.

Five, in the embodiment including a sleeve to be connected to the exposed open end of the tail pipe, the tubular sleeve comprises a wall member having a configuration substantially the same as the configuration of the exposed end of the tail pipe. Whether the sleeve fits over or is inserted into the exposed open end of the tail pipe, it fits snug therewith. The exposed open end of the tail pipe and an adjacent internal hollow body portion are usually of substantially the same configuration. In the embodiment where the sleeve is inserted into this exposed open end, the sleeve has a wall member with an external configuration substantially the same as the internal configuration of the open outer end and adjacent internal hollow body portion of the tail pipe. Consequently, the sleeve, upon being inserted into the open outer end and adjacent internal hollow body portion, fits snug within the tail pipe, with the sleeve's and tail pipe's respective longitudinal axes being coextensive. When the sleeve is fitted over the exposed, open end of the tail pipe, the sleeve has a wall member with an internal configuration substantially the same as the external configuration of the open outer end. A widely used sleeve configuration is cylindrical, although it may have other shapes such as, for example, oval, rectangular, hexagonal, etc. Typically, a cylindrical sleeve comprises a substantially cylindrical wall member having an inside diameter from about 2 to about 7 inches, a length from about ¼ to about 6 inches, and a thickness from about ⅛ to about ½ inches.

Six, the ornamental element may have a body member with opposed ends. The ornamental element may have at least two connector arms extending outwardly from the body member in substantially opposed directions. Each arm has a terminal end attached to an inner surface portion of the tubular member or sleeve, as the case may be. In one embodiment, each opposed end is spaced substantially the same distance from an inner surface portion of the tubular member or sleeve, as the case may be. Typically, this arrangement is employed when the outer end lies in a plane that is at substantially a right angle with respect to the longitudinal axis. In another embodiment, the body member is positioned off center. Typically this arrangement is employed when the outer end of the tubular member or the sleeve lies in a plane that is at an acute angle with respect to its longitudinal axis. For example, the acute angle may be from about 35 to 85 about degrees, typically 45 about degrees. In this situation, the body member is offset with respect to the longitudinal axis so that one of its opposed ends is closer to an inner wall of the tubular member or sleeve, as the case may be, than the other opposed end.

Seven, it is desirable, but not absolutely necessary, to include a fastener element that enables the tail pipe ornament to be connected to the tail pipe in a fixed position relative to the tail pipe. This fastener element may be between the ornamental element and the inner end of the sleeve.

These features are not listed in any rank order nor is this list intended to be exhaustive.

This invention also includes a method of decorating a tail pipe of an automotive exhaust system where the tail pipe has a passageway through which exhaust gas flows and exits an exposed, open end of the tail pipe. This method comprises connecting to the tail pipe an ornamental element including a symbol at or near said exposed, open end of the tail pipe. The ornament is positioned so that an observer when looking at the exposed, open end of the tail pipe would see the symbol. The ornamental element may be constructed as discussed above and it may be integral with a tail pipe or be a separate sleeve attached to the tail pipe as discussed above.

### DESCRIPTION OF DRAWING

Some embodiments of this invention, illustrating all its features, will now be discussed in detail. These embodiments depict the novel and non-obvious tail pipe, tail pipe ornament, and method of this invention as shown in the accompanying drawing, which is for illustrative purposes only. This drawing includes the following figures (Figs.), with like numerals indicating like parts:

FIG. 1 is a an exploded perspective view of one embodiment of the tail pipe ornament of this invention having an ornamental element seated within a sleeve adapted to be inserted into an exposed, open end of a tail pipe of an automotive exhaust system.

FIG. 1A is a perspective view showing the tail pipe ornament depicted in FIG. 1 inserted into the tail pipe of an automotive exhaust system.

FIG. 1B is a cross-sectional view taken along line 1B-1B of FIG. 1A.

FIG. 2A is a plan view of a tail pipe having an exposed, open end that is at an acute angle with respect to a longitudinal axis of the tail pipe.

FIG. 2B is a perspective view of the tail pipe shown in FIG. 2A.

FIG. 2C is a side view of the tail pipe shown in FIG. 2A, with a section broken away.

FIG. 2D is an end view taken along line 2D-2D of FIG. 2C.

FIG. 3A is a perspective view of an embodiment of the tail pipe ornament of this invention adapted to be inserted into the tail pipe shown in FIGS. 2A through 2D.

FIG. 3B is another perspective view of the embodiment of this invention shown in FIG. 3A taken from a different angle.

FIG. 3C is a cross-sectional view taken along line 3C-3C of FIG. 3B.

FIG. 3D is an end view of the tail pipe ornament shown in FIG. 3A looking into its open end along its longitudinal axis.

FIG. 4A is a plan view of the tail pipe ornament (shown in phantom lines) illustrated in FIGS. 3A through 3D inserted into the outer end of the tail pipe illustrated in FIGS. 2A through 2D.

FIG. 4B is a perspective view taken from a different angle of the tail pipe ornament (shown in phantom lines) illustrated in FIGS. 3A through 3D inserted into the outer end of the tail pipe illustrated in FIGS. 2A through 2D.

FIG. 4C is a partial cross-sectional view taken along line 4C-4C of FIG. 4A.

FIG. 4D is an end view of the assembled tail pipe ornament and tail pipe from an observer's point of view looking into the exposed, open end along the longitudinal axis of this assembly.

FIG. 5 is a perspective view depicting an alternate embodiment of this invention where a tail pipe adapted to be attached to an automotive exhaust system has an ornamental element mounted within the tail pipe.

FIG. 5A is a cross-sectional view taken along line 5A-5A of FIG. 5.

FIG. 6 is a perspective view depicting another alternate embodiment of this invention where a tail pipe adapted to be attached to an automotive exhaust system has an ornamental element mounted within the tail pipe.

FIG. 6A is a cross-sectional view taken along line 6A-6A of FIG. 6 FIG. 7A depicts a series of ornamental elements in the form of numbers in outline that are adapted to be attached at or near an open end of the tail pipe ornament adapted to be inserted into a tail pipe or attached directly to the outer end of a tail pipe.

FIG. 7B depicts a series of ornamental elements in the form of solid Roman letters that are adapted to be attached at or near an open end of the tail pipe ornament adapted to be inserted into a tail pipe or attached directly to the outer end of a tail pipe.

FIG. 7C depicts a series of ornamental elements in the form of Roman numerals in outline that are adapted to be attached at or near an open end of the tail pipe ornament adapted to be inserted into a tail pipe or attached directly to the outer end of a tail pipe.

FIG. 8A is a cross-sectional view of one embodiment of the tail pipe ornament of this invention having an ornamental element seated within a sleeve adapted to be fitted over an exposed, open end of a tail pipe of an automotive exhaust system.

FIG. 8B is an end view taken along line 8B-8B of FIG. 8A.

FIG. 8C is a cross-sectional view of another embodiment of the tail pipe ornament of this invention having an ornamental element seated within a sleeve adapted to be fitted over an exposed, open end of a tail pipe of an automotive exhaust system.

FIG. 9A is an end view of an embodiment of this invention where the ornamental element is formed by cutting into a solid plate member an opening in the shape of a symbol.

FIG. 9B is a cross-sectional view taken along line 9B-9B of FIG. 9A.

### DETAILED DESCRIPTION OF SOME EMBODIMENTS OF THIS INVENTION

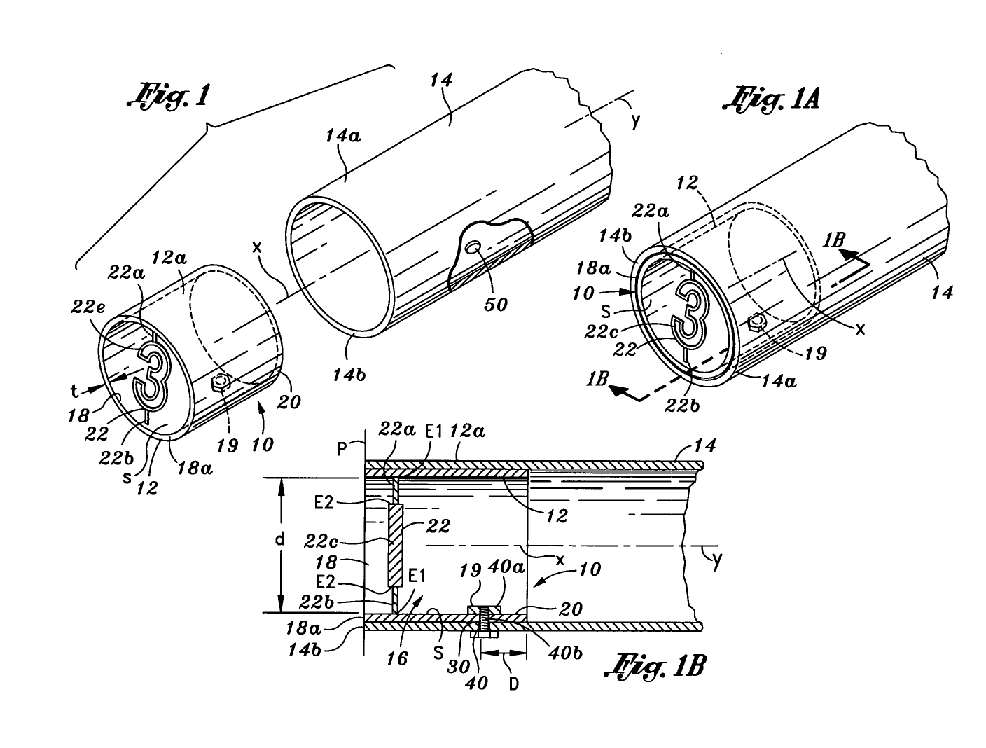

As shown in FIGS. 1, 1A and 1B, one embodiment of this invention a tail pipe ornament 10, includes a sleeve 12 adapted to fit snug within a tail pipe 14 of an automotive exhaust system. The sleeve 12 comprises a substantially cylindrical wall member 12a having an inside diameter d from 2 to 7 inches, a length 1 from ¼ to 6 inches, and a thickness t from ⅛ to ½ inches. It has a longitudinal passageway 16 extending between an open outer end 18 and an open inner end 20 of the sleeve. An ornamental element 22 is located at or near the outer end 18, and it may be a symbol, such as, for example, the number “3.” A fastener element 19 (FIG. 1B) located between the ornamental element 22 and the inner end 20, usually adjacent this inner end, enables the tail pipe ornament 10 to be connected to the tail pipe 14 in a fixed position relative to the tail pipe. This fastener 19 includes a nut 40a welded to an inner surface portion S of the sleeve 12. A hole 30 is drilled, or otherwise formed, in the sleeve 12 at a distance D from the inner end 22 opposite the nut 40a so that a bolt 40 (FIG. 1B) may be threaded into the nut 40a.

The sleeve 12 and ornamental element 22 may be made of stainless steel and may be chrome plated. Optionally, the ornamental element 22 may be painted with a light reflective material. In this embodiment, the ornamental element 22 is positioned centrally in the outer end 18, which, as depicted in FIGS. 1A and 1B, has a circular edge 18a that lies in a plane P that is at a right angle to the longitudinal axis X of the sleeve 12.

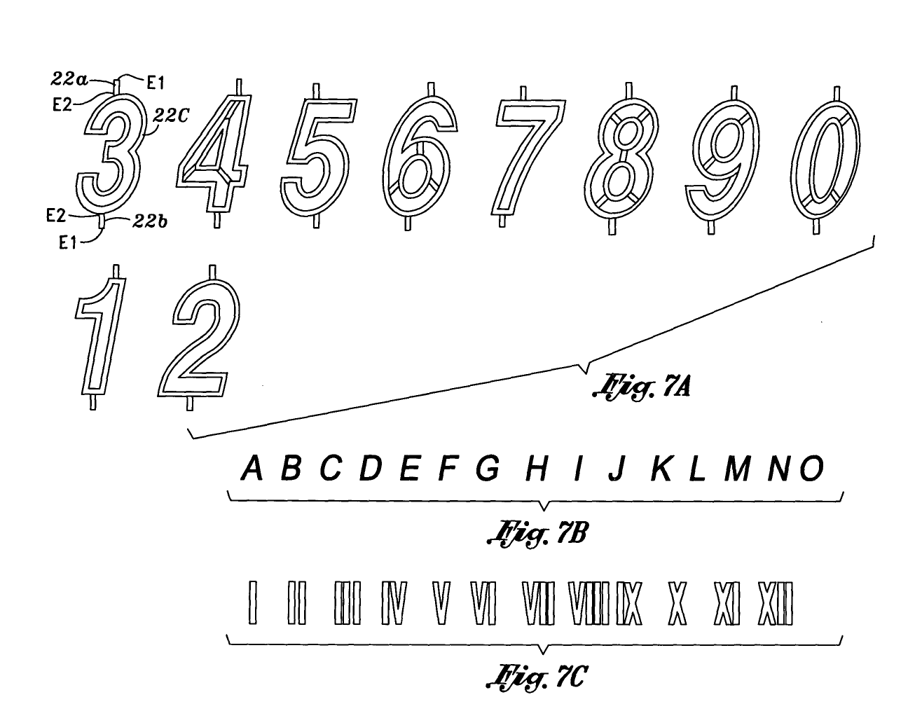

As illustrated best in FIGS. 1 through 1B, the ornamental element 22 is mounted centrally in a stationary position. To achieve this, the ornamental element 22 has at least two connector arms 22a and 22b (FIG. 7A) extending outwardly from its body 22c pointing in substantially opposed directions. Each arm 22a and 22b has an outer terminal end E1 welded to the inner surface portion S of the sleeve 12 to hold the ornamental element 22 in a stationary position at or near the open end 18 and an inner terminal end E2 welded to opposite ends of the body 22c of the ornamental element 22.

The ornamental element 22 may be a solid structure that prevents exhaust gas from flowing through it, or it may be an open structure that allows exhaust gas to flow it. In the tail pipe ornament 10, the ornamental element 22 is in the shape of the number “3” in outline form so that gas flows through it. This “open” number “3” in outline is made by bending wire into the desired shape. As discussed subsequently in greater detail, this ornamental element 22 may take many different shapes such as, for example, depicted in FIGS. 7A, 7B, and 7C. It is sized to provide sufficient space to allow exhaust gas to flow through the passageway 16 in the sleeve 12, entering the inner end 20 and then flowing past the ornamental element, exiting the outer end 18. Usually, the outer end 18 has a maximum total area from 8 to 20 square inches and the ornamental element occupies no more than 90 percent of this maximum total area. The sleeve 12 has a configuration substantially the same as the exposed, open end 14a of the tail pipe 14; in this embodiment, the sleeve 12 is cylindrical, but it may have other shapes with different cross-sectional configurations, such as, for example, rectangular, square, oval, hexagonal, etc. depending on the shape of the exposed, open end 14a of the tail pipe 14.

In use, a hole 50 is first drilled into tail pipe 14. The distance of this hole 50 from the exposed end 14a of the tail pipe 14 is equal to the distance D from the inner end 20 of the sleeve 12 to the hole 30 in the sleeve. This enables the nut 40a and hole 30 to be aligned with the hole 50 upon pushing the sleeve 12 into the exposed end 14a of the tail pipe 14. The sleeve 12, fitting snug within the tail pipe 14 with the holes 30 and 50 aligned, has the edge 18a of the open outer end 18 substantially flush with the edge 14b of the tail pipe 14. The stem 40b of the bolt 40 is then passed through the holes 30 and 50 and screwed into the nut 40a to hold the tail pipe ornament 10 securely in position with the longitudinal axis X of the sleeve 12 co-extensive with the longitudinal axis Y of the tail pipe 14.

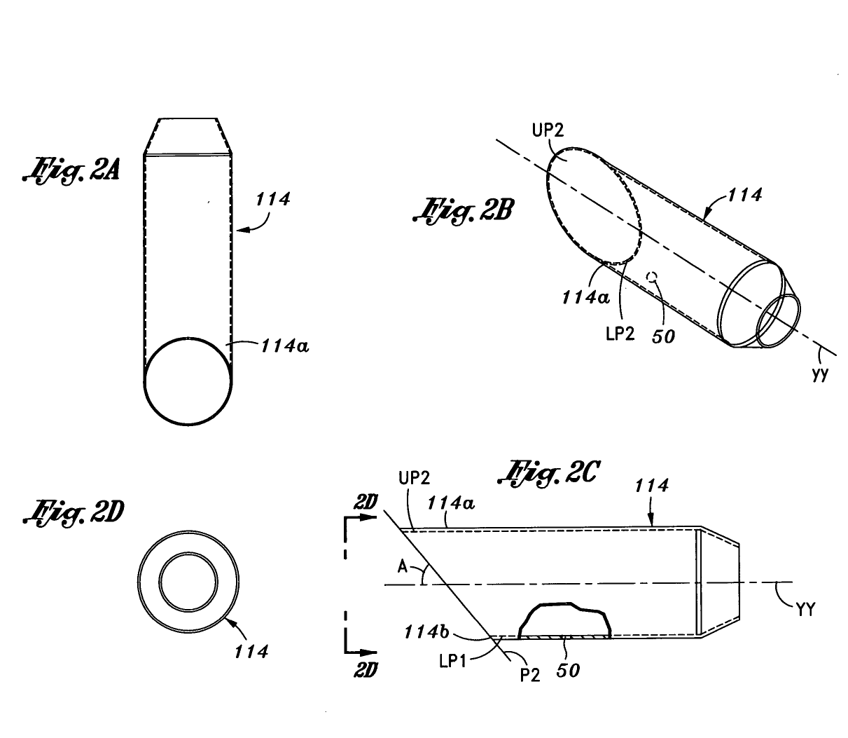

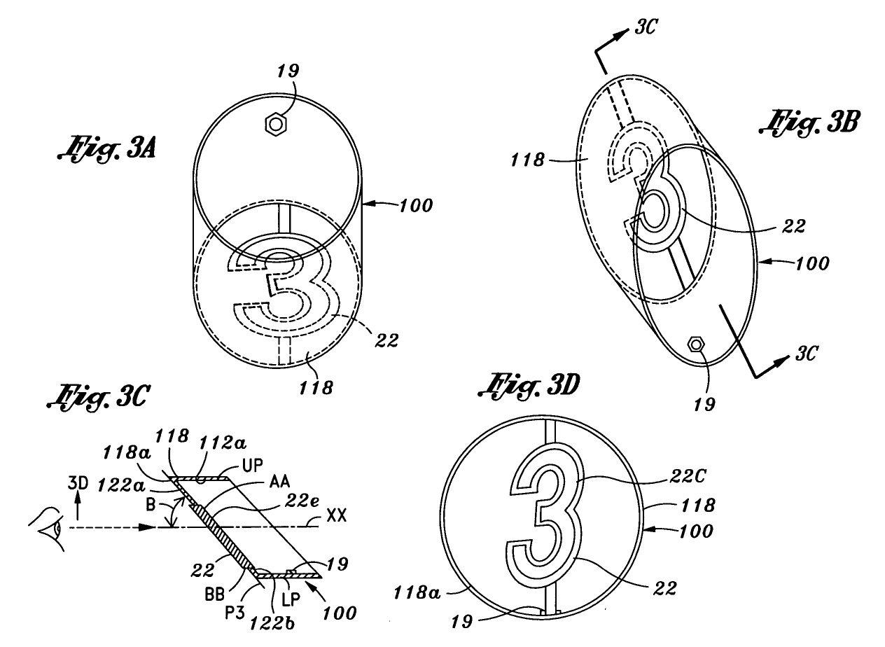

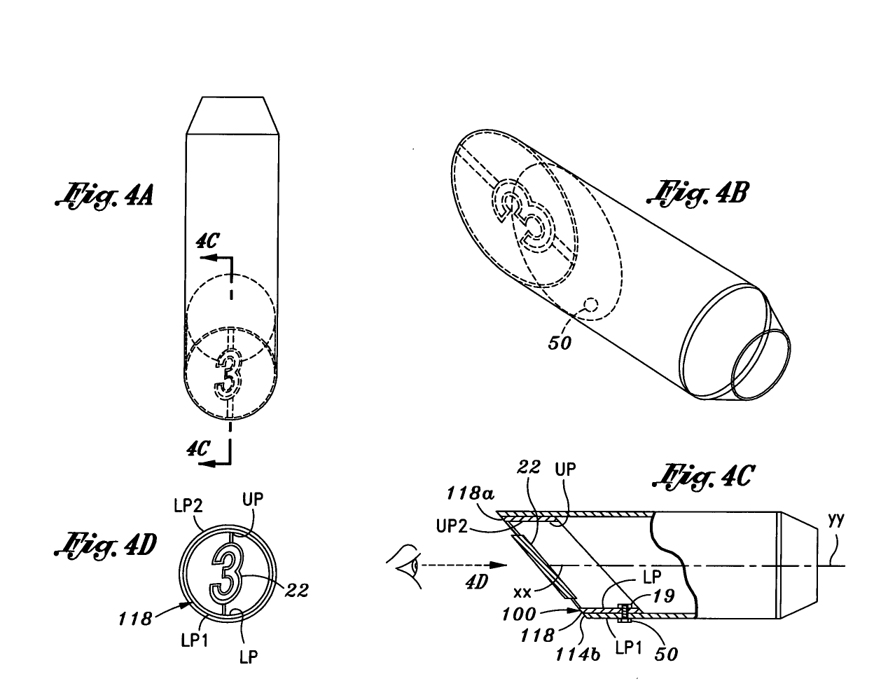

As shown in FIGS. 3A through 3D, an embodiment of this invention, a tail pipe ornament 100, is designed to be used with a tail pipe exhaust system having a tail pipe 114 (FIGS. 2A through 2D) terminating in an exposed open end 114a that lies in a plane P2 that is at an acute angle A with respect to the longitudinal axis YY of the tail pipe. Typically, the acute angle A is from about 35 to about 85 degrees. Thus, as best shown in FIGS. 2B and 2C, the exposed, open end 114a of the tail pipe 114 has a lower portion LP1 that is inward with respect to an upper portion UP1 of the end 114a. The edge 114b (FIG. 2B) at the exposed open end 114a is chamfered at essentially the same acute angle A as the end 114a.

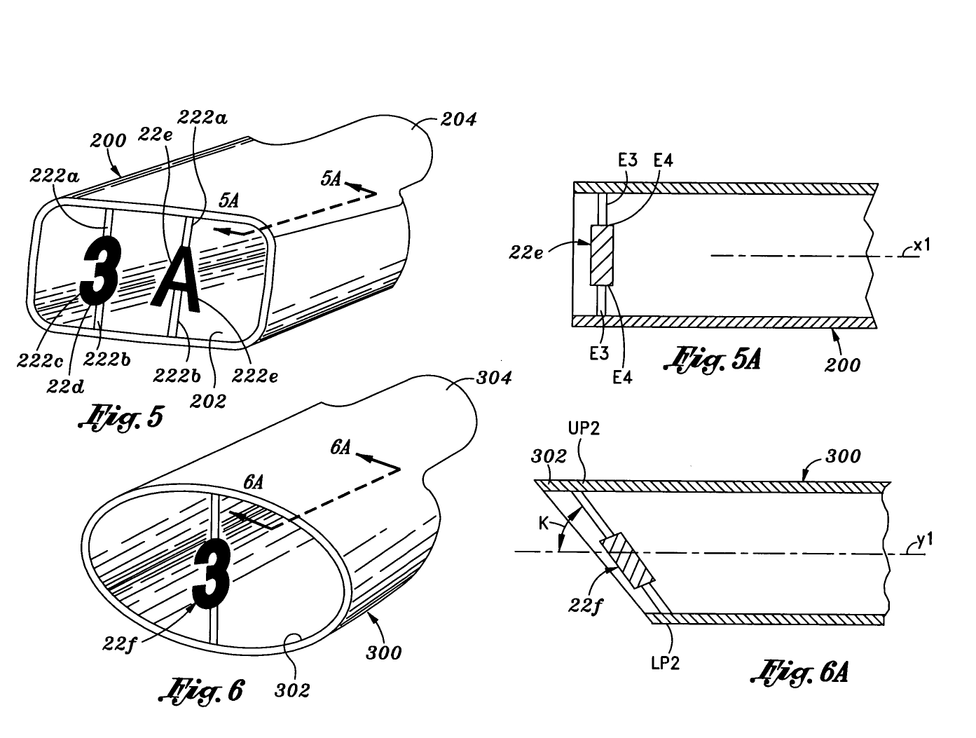

The tail pipe ornament 100 to be inserted into the exposed open end 114a of the tail pipe 114 is essentially the same as the tail pipe ornament 10, except as best shown in FIGS. 3C and 4C, the outer end 118 of its sleeve 112 lies in a plane P3 that is at an acute angle B with respect to the longitudinal axis XX of the sleeve 112 and the ornamental element 22 is positioned off center in the outer end 118 of the sleeve 112. Thus, as shown in FIG. 3C, the sleeve 112 has a lower portion LP of the edge 118a of the outer end 118 that is inward with respect to an upper portion UP of the edge 118a. The edge 118a at the outside end 118 is chamfered at essentially the same acute angle B as the outside end 118. Moreover, the acute angles A and B are substantially equal.

In contrast to the tail pipe ornament 10 the ornamental element 22 is displaced with respect to the longitudinal axis XX of the sleeve 112 so that its end BB is closer than its end AA to the cylindrical wall member 112a forming the sleeve 112. Consequently, its connector arm 122a is a little longer than its connector arm 122b, both of which have their opposed ends welded respectively to the wall member 112 and the body 22c of the ornamental element 22. As with the tail pipe ornament 10, the fastener 19 includes the nut 40a that is welded to the inside surface S of the cylindrical wall member 112a. This nut 40a aligned with the hole 30 in the wall member that is at a distance D from its inner end, as discussed above. There is the hole 50 is formed in the tail pipe 114 at the appropriate distance from the inward lower portion LP1 of the end 114a so that the nut 40a and hole 30 are aligned with the hole 50 upon pushing the sleeve 112 into open exposed open end 114a of the tail pipe 114. Consequently, the sleeve may be attached to the tail pipe in a fixed position by the bolt 40.

As illustrated in FIGS. 4A through 4E, upon properly orienting the tail pipe ornament 100 with the tail pipe 114 and inserting tail pipe ornament 100 into the exposed open end 114a, the hole 50 is aligned with the nut 40a and hole 30 in the sleeve. The sleeve 112, fitting snug within the tail pipe 114 with the holes 30 and 50 aligned, has the edge 118a of the open outer end 118 substantially flush with the edge 114b of the tail pipe 114. The chamfered edges 114b and 118a are also substantially flush with each other. The stem 40b of the bolt 40 is then passed through the holes 30 and 50 and screwed into the nut 40a to hold the tail pipe ornament 100 securely in position with the longitudinal axis XX of the sleeve 112 co-extensive with the longitudinal axis YY of the tail pipe 114. As illustrated in FIGS. 4C and 4D, with the sleeve 112 inserted into the tail pipe 114 and the ornamental element 22 displaced and at an acute angle as discussed above, a viewer, looking along the longitudinal axis YY into the open end 118 of the sleeve 112, will see the ornamental element equally spaced between the upper portion UP and lower portion LP.

In both embodiments, the tail pipe ornaments 10 and 100, are each configured to fit snuggly into the open outer end and adjacent internal hollow body portion of the tail pipe into which they are inserted. In other words, they each have an external configuration that is substantially the same as the internal configuration of the open outer end and adjacent internal hollow body portion of the tail pipe into which they are inserted.

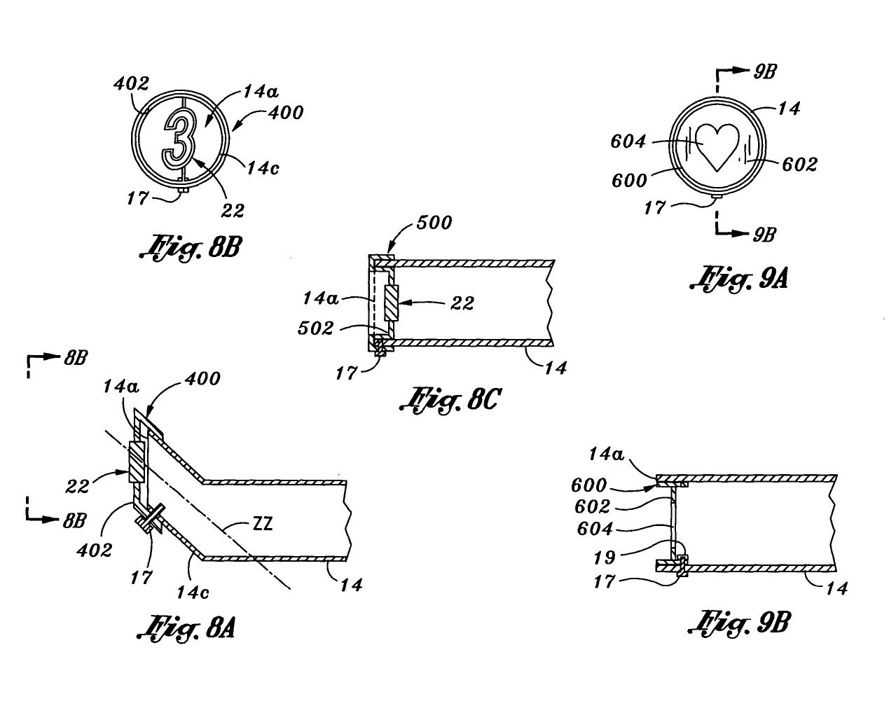

Other embodiments of this invention may include a tail pipe 200 (FIGS. 5 and 5A), a tail pipe 300 (FIGS. 6 and 6A), a sleeve 400 (FIG. 8A), a sleeve 500 (FIG. 8A), and a sleeve 600 (FIGS. 9A and 9B).

The tail pipes 200 and 300 are tubular members that have one or more ornamental elements in their respective open outside ends 202 and 302. There are two stationary ornamental elements 22d and 22e in the open end 202 of the tail pipe 200 and only one stationary ornamental element 22f. In these embodiments the ornamental elements 22d, 22e, and 22f are solid, but they may be open structures that allow exhaust gas to flow through them. The open end 202 has a rectangular configuration and the open end 302 has an oval configuration. Typically, each tail pipe 200 and 300 has open inside ends 204 and 304, respectively, that are cut to lie in a plane that is at substantially a right angle to their respective longitudinal axes X1 and Y1 of these tail pipes. These ends 204 and 304 are welded to the outlets (nor shown) of an automotive exhaust system (not shown).

In the tail pipe 200, the ornamental elements 22d and 22e are centrally positioned on opposite sides of the longitudinal axis X1. The open outside end 202 lies in a plane is at a right angle to its longitudinal axis X1, and the ornamental elements 22d and 22e each have connector arms 222a and 222b extending outward in substantially opposite directions from their respective bodies 222c. These arms 222a and 222b are of substantially the same length and their opposed terminal ends E3 and E4 (FIG. 5) are respectively welded to the inside of the tail pipe 200 and the ornamental element 22d or 22e, as the case may be. The ornamental elements 22d and 22e, including their associated arms 222a and 222b and bodies 222c, lie in a plane that is at substantially a right angle to the longitudinal axis X1.

In the tail pipe 300, its outside end 302 is cut at acute angle D with respect to its longitudinal axis Y1. The ornamental element 22f is displaced so that its body 222c is closer to the lower portionLP2 of the tail pipe 300 than the upper portionUP2. This is similar to the placement of the ornamental element 22 in the tail pipe ornament 100. The ornamental element 22f, including its associated arms 222a and 222b and body 222c, is positioned within the open end 302 at the same acute angle as the open end 302, namely, the acute angle K. Typically, the edge 302a of the open end 302 is chamfered at the same angle K. Thus, with the ornamental element 22f displaced and at an acute angle as discussed above, a viewer, looking along the longitudinal axis Y1 into the open end 302 of the tail pipe, will see the ornamental element 22f equally spaced between the upper portion UP2 and lower portion LP2.

FIGS. 8A and 8B show the sleeve 400 connected to the exposed open end 14a of the tail 14 which is bent to provide the section 14c which includes the exposed open end 14a. FIG. 8C depicts the sleeve 500 connected to the exposed open end of a straight tail pipe 14. The sleeves 400 and 500 are both tubular members that have one or more ornamental elements, for example, the ornamental element 22 corresponding to the number “3” in their respective open outside ends 402 and 502. Since the bent section 14c points upward, the ornamental element may be centrally located in the exposed open end 14a even though this end is at an acute angle with respect to the axis ZZ of the bent section.

Both of these sleeves 400 and 500 have a configuration substantially the same as the exposed open ends of the tail pipe 14 to which they are connected, for example, circular. Unlike the sleeves 12 and 100, respectively illustrated in FIGS. 1 through 1B and 3A through 3D, the sleeves 400 and 500 fit over the exposed open end 14a of the tail pipe 14 rather than inside these ends. In the sleeve 400, the ornamental element 22 is positioned on the outside of the exposed open end 14a of the tail pipe 14. In the sleeve 500, the ornamental element 22 is positioned on the inside of the exposed open end 14a of the tail pipe 14.

In the embodiment depicted in FIGS. 9A and 9B, the sleeve 600 fits within the exposed open end 14a of the tail pipe 14, and it includes a solid plate 602. The ornamental element 604 comprises an opening cut into the plate 602 in the form of a heart.

The sleeves 400, 500, and 600 may include a fastener 17 that connects these sleeves to the tail pipe 14 so that they are in a fixed position relative to the tail pipe. Nevertheless, if a very tight fit is achieved, the fastener 17 may be eliminated.

In all the embodiments discussed above, the ornamental elements are substantially planar. These ornamental elements discussed above, including their associated arms and bodies, have a height from about 2 to about 7 inches and a width from about to about 2 to about 7 inch. Their bodies are relatively thin, having a thickness that does not exceed about 1 inch, for example, from about ⅛ to about ½ inch. Their connector arms are stainless steel wires having a diameter of about ⅛ inch and a length from about ½ to about 1 inch, depending on the location of the ornamental elements to which they are attached. The bodies of the ornamental elements discussed above may be solid or formed by bent wires in outline. They may be, for example, Roman letters as shown in FIG. 7A, or Arabic numerals as shown in FIG. 7B, or Roman numerals as shown in FIG. 7C. They may be other symbols also, for example, Chinese, Hebrew, Arabic, Greek, Russian, or Sanskrit characters; signs of the Zodiac; standard ornamental shapes such as, for example, a heart, diamond, club, spade; trademark logos; etc. In all the embodiments discussed above, it is desirable to chrome plate the entire structure, including the ornamental elements and their associated arms and bodies.

### SCOPE OF THE INVENTION

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention:

1. A tail pipe for an automotive exhaust system comprising
a tubular member providing a passageway through which exhaust gas flows between an outer end and an inner end of the tubular member, said inner end being adapted to be attached to an automotive exhaust system, and
an ornamental element located at or near said outer end, said ornamental element including a symbol and being sized to provide sufficient space to allow exhaust gas to flow through the tubular member and past the ornamental element.

2. The tail pipe of claim 1 where the ornamental element is stationary and is in the shape of the symbol.

3. The tail pipe of claim 2 where the ornamental element is essentially a solid structure that prevents exhaust gas from flowing there through.

4. The tail pipe of claim 2 where the ornamental element is essentially an open structure that allows exhaust gas to flow there through.

5. The tail pipe of claim 1 where the outer end has a maximum total area and the ornamental element occupies no more than 90 percent of said maximum total area.

6. The tail pipe of claim 5 where said maximum total area is from 8 to 20 square inches.

7. The tail pipe of claim 1 where the tubular member and ornamental element are made of stainless steel.

8. The tail pipe of claim 7 where the tubular member and ornamental element are chrome plated.

9. The tail pipe of claim 1 where the ornamental element has a body member with opposed ends, with each opposed end spaced from an inner surface portion of the tubular member substantially the same distance.

10. The tail pipe of claim 1 where the ornamental element has a body member that is positioned off center in the outer end.

11. The tail pipe of claim 1 where the ornamental element has at least two connector arms extending outwardly from a body member of the ornamental element in substantially opposed directions, each arm having a terminal end attached to an inner surface portion of the tubular member.

12. The tail pipe of claim 1 where the outer end is at an acute angle with respect to a longitudinal axis of the tubular member.

13. The tail pipe of claim 12 where the acute angle is from 35 to 85 degrees.

14. The tail pipe of claim 1 where the symbol is in the form of letters or numbers or combinations thereof.

15. The tail pipe of claim 1 where the ornamental element has at least a portion that is light reflective.

16. The tail pipe of claim 16 where the portion that is light reflective corresponds to the symbol.

17. A tail pipe for an automotive exhaust system comprising
a tubular member having a central axis and providing a passageway extending between an outer end and an inner end of the tubular member, said outer end being at an acute angle from 35 to 85 degrees with respect to said axis of the tubular member and said inner end being adapted to be attached to an automotive exhaust system,
a stationary ornamental element in the shape of a symbol located at or near said outer end and sized to provide sufficient space to allow exhaust gas to flow through the tubular member and past the ornamental element,
said ornamental element including a body member having opposed ends, said body member being offset with respect to the axis of the tubular member so that one of said opposed ends is closer to an inner wall of the tubular member than the other opposed end.

18. The tail pipe of claim 17 where the ornamental element has at least two connector arms extending outwardly from the body member in substantially opposed directions, each arm having a terminal end attached to an inner surface portion of the tubular member.

19. A tail pipe ornament comprising
a sleeve adapted to be connected to an exposed end of a tail pipe of an automotive exhaust system, said sleeve having a passageway extending between an outer end and an inner end of the sleeve, and
an ornamental element located at or near said outer end, said ornamental element including a symbol,
said ornamental element being sized to provide sufficient space to allow exhaust gas to flow through the sleeve and past the ornamental element.

20. The tail pipe ornament of claim 19 where the sleeve fits snug within the exposed end of the tail pipe.

21. The tail pipe ornament of claim 19 where the sleeve fits over the exposed end of the tail pipe.

22. The tail pipe ornament of claim 19 where the ornamental element is stationary and is in the shape of the symbol.

23. The tail pipe ornament of claim 22 where the ornamental element is essentially a solid structure that prevents exhaust gas from flowing there through.

24. The tail pipe of claim 22 where the ornamental element is essentially an open structure that allows exhaust gas to flow there through.

25. The tail pipe ornament of claim 19 where the outer end has a maximum total area and the ornamental element occupies no more than 90 percent of said maximum total area.

26. The tail pipe ornament of claim 25 where said maximum total area is from 8 to 20 square inches.

27. The tail pipe ornament of claim 19 where the sleeve and ornamental element are made of stainless steel.

28. The tail pipe ornament of claim 27 where the sleeve and ornamental element are chrome plated.

29. The tail pipe ornament of claim 19 where the ornamental element has a body member with opposed ends, with each opposed end spaced from an inner surface portion of the sleeve substantially the same distance.

30. The tail pipe ornament of claim 19 where the ornamental element is positioned off center in the outer end.

31. The tail pipe of claim 19 where the ornamental element has at least a portion that is light reflective.

32. The tail pipe of claim 31 where the portion that is light reflective corresponds to the symbol.

33. The tail pipe ornament of claim 19 where the outer end is at an acute angle with respect to a longitudinal axis of the sleeve.

34. The tail pipe ornament of claim 33 where the acute angle is from 35 to 85 degrees.

35. The tail pipe ornament of claim 19 where the symbol is in the form of letters or numbers or combinations thereof.

36. The tail pipe ornament of claim 19 where the exposed end of a tail pipe has a predetermined configuration and the sleeve comprises a wall member having a configuration substantially the same as the predetermined configuration of the exposed end of the tail pipe.

37. The tail pipe ornament of claim 36 where the sleeve has an inside diameter from 2 to 7 inches, a length from ¼ to 6 inches, and a thickness from ⅛ to ½ inch.

38. The tail pipe ornament of claim 19 including a fastener element that enables the tail pipe ornament to be connected to a tail pipe of an automotive exhaust system in a fixed position relative to the tail pipe.

39. The tail pipe ornament of claim 38 where the fastener element is between the ornamental element and the inner end.

40. The tail pipe ornament of claim 19 where the ornamental element includes a body member having at least two connector arms extending outwardly from the body member in substantially opposed directions, each arm having a terminal end attached to an inner surface portion of the sleeve.

41. A tail pipe ornament including
a sleeve comprising a wall member having a predetermined configuration substantially the same as the configuration of an exposed end of the tail pipe to which said sleeve is to be attached.
said sleeve having a longitudinal axis and providing a passageway extending between an outer end and an inner end of the sleeve, said outer end being at an acute angle from 35 to 85 degrees with respect to said longitudinal axis of the sleeve,
a stationary ornamental element in the shape of a symbol located at or near said outer end and sized to provide sufficient space to allow exhaust gas to flow through the sleeve and past the ornamental element,
said ornamental element including a body member having opposed ends, said body member being offset with respect to the longitudinal axis of the sleeve so that one of said opposed ends is closer to the wall member than the other opposed end, and
a fastener element that enables the tail pipe ornament to be connected to a tail pipe of an automotive exhaust system in a fixed position relative to the tail pipe.

42. A tail pipe ornament comprising
a sleeve having a longitudinal axis and a wall member forming a longitudinal passageway extending between an outer end and an inner end of the wall member,
a fastener element along the wall member that enables the sleeve to be connected to an automotive exhaust tail pipe in a fixed position relative to the tail pipe, and
a stationary ornamental element in the shape of a symbol located at or near the outer end of the sleeve,
said ornamental element being sized to provide a sufficient space to allow exhaust gas to flow through the sleeve and past the ornamental element.

43. The tail pipe ornament of claim 42 where the ornamental element has a body member with opposed ends, with each opposed end spaced from an inner surface portion of the wall member substantially the same distance.

44. The tail pipe ornament of claim 42 where the outer end is at an acute angle with respect to the longitudinal axis of the sleeve and the ornamental element has opposed ends and is offset with respect to the longitudinal axis of the sleeve so that one of said opposed ends of the ornamental element is closer to the wall member than the other opposed end of the ornamental element.

45. The tail pipe ornament of claim 42 where the fastener element is between the ornamental element and the inner end.

46. The tail pipe ornament of claim 39 where the ornamental element is light reflective.

47. In combination, a tail pipe of an automotive exhaust system and a tail pipe ornament,
said tail pipe having a longitudinal axis and an exposed end having a predetermined configuration, and
said tail pipe ornament including
a sleeve having a longitudinal axis and a wall member with a configuration substantially the same as the predetermined configuration of said exposed end of the tail pipe,
said wall member forming a passageway extending between an outer end and an inner end of the sleeve, and
an ornamental element in the shape of a symbol
located at or near the outer end of the sleeve,
said sleeve being connected to the exposed end of the tail pipe with the longitudinal axis of the sleeve and the longitudinal axis of the tail pipe being coextensive and said ornamental element being sized to provide a sufficient space to allow exhaust gas to flow through the sleeve and past the ornamental element.

48. The tail pipe ornament of claim 47 where the sleeve fits snug within the exposed end of the tail pipe.

49. The tail pipe ornament of claim 47 where the sleeve fits over the exposed end of the tail pipe.

50. The combination of claim 47 where the ornamental element is stationary.

51. The combination of claim 47 where the outer end of the sleeve has a maximum total area and the ornamental element occupies no more than 90 percent of said maximum total area.

52. The combination of claim 47 where said maximum total area is from 8 to 20 square inches.

53. The combination of claim 47 where the open outer end of the tail pipe is at an acute angle and the outer end of the sleeve is at substantially the same acute angle as said open outer end of the tail pipe.

54. The combination of claim 53 where the ornamental element is positioned off center in the outer end of the sleeve at a sufficient distance to enable the entire ornamental element to be seen when looking directly into the open outer end of the tail pipe.

55. The combination of claim 47 where the outer end of the sleeve and the exposed end of the tail pipe are substantially flush.

56. The combination of claim 47 where the exposed end and an adjacent internal hollow body portion of the tail pipe and the sleeve are of cylindrical configuration, with the sleeve having an outside diameter substantially the same as an inside diameter of the exposed end and the adjacent internal hollow body portion of the tail pipe.

57. The combination of claim 47 where the ornamental element includes a body member having at least two connector arms extending outwardly from the ornamental element in substantially opposed directions, each arm having a terminal end attached to an inner surface portion of the sleeve.

58. A method of decorating a tail pipe of an automotive exhaust system where the tail pipe has a passageway through which exhaust gas flows and exits an exposed, open end of the tail pipe, said method comprising
connecting to the tail pipe an ornamental element including a symbol at or near said exposed, open end of the tail pipe,
said ornamental element being positioned so that an observer when looking at the exposed, open end of the tail pipe would see the symbol and being sized to provide sufficient space to allow exhaust gas to flow through the tubular member and past the ornamental element.

59. The method of claim 58 where the ornamental element is stationary and is in the shape of the symbol.

60. The method of claim 58 where the ornamental element is essentially a solid structure that prevents exhaust gas from flowing there through.

61. The method of claim 58 where the ornamental element is essentially an open structure that allows exhaust gas to flow there through.

62. The method of claim 58 where said exposed, open end has a maximum total area and the ornamental element occupies no more than 90 percent of said maximum total area.
